(19) United States
(12) Patent Application Publication
(10) Pub. No.: US 2019/0354271 A1
(43) Pub. Date: Nov. 21, 2019

(54) TRANSDUCER PROGRAMMER

(71) Applicant: NRG HOLDINGS, LLC, Brooklyn, NY (US)

(72) Inventor: PAUL CELICOURT, Brooklyn, NY (US)

(73) Assignee: NRG HOLDINGS, LLC, Brooklyn, NY (US)

(21) Appl. No.: 15/983,931

(22) Filed: May 18, 2018

(51) Int. Cl. G06F 3/0484; G06F 3/0482; G06F 17/30; G06F 8/41

(52) U.S. Cl. CPC G06F 3/04847; G06F 8/41; G06F 17/30528; G06F 3/0482

(57) ABSTRACT

Technologies are described for devices and methods to program a transducer. The methods may comprise a processor gathering a set of characteristics of the transducer. The methods may comprise the processor comparing the characteristics to a database of transducer profiles. The methods may comprise the processor determining first transducer profile data for the transducer from the database. The methods may comprise the processor generating interface data based on the characteristics and the first transducer profile data. The methods may comprise the processor sending the interface data to a graphic user interface. The methods may comprise the processor receiving a selection from the graphic user interface. The methods may comprise the processor compiling the selection, the characteristics, and the first transducer profile data into second transducer profile data. The methods may comprise the processor generating instructions for the transducer based on the second transducer profile data.

### BACKGROUND

Unless otherwise indicated herein, the materials described in this section are not prior art to the claims in this application and are not admitted to be prior art by inclusion in this section.

A transducer may be used in automation, measurement, and control systems. A transducer may convert a signal in one form of energy to a signal in another form of energy. A transducer may convert a physical quantity such as heat, light, force motion, energy, etc. to an electric signal and may also convert an electric signal to a physical quantity. One or more transducers may be deployed to one or more locations to collect environmental data or control an environmental process.

### SUMMARY

One embodiment of the invention is a method to program a transducer. The methods may comprise, by a processor, gathering a set of characteristics of the transducer. The methods may comprise the processor comparing the characteristics of the transducer to a database of transducer profiles. The methods may comprise the processor determining first transducer profile data for the transducer from the database of transducer profiles. The first transducer profile data may be based on the characteristics. The methods may comprise the processor generating interface data based on the characteristics and the first transducer profile data. The methods may comprise the processor sending the interface data to a graphic user interface. The methods may comprise the processor receiving a selection from the graphic user interface. The methods may comprise the processor compiling the selection, the characteristics, and the first transducer profile data into second transducer profile data. The methods may comprise the processor generating instructions for the transducer based on the second transducer profile data.

Another embodiment of the invention includes a device effective to program a transducer. The device may comprise a transceiver. The device may comprise a memory. The device may comprise a processor. The processor may be effective to be in communication with the transceiver and the memory. The processor may be effective to gather characteristics of the transducer by the transceiver. The processor may be effective to compare the characteristics of the transducer to the database of transducer profiles. The processor may be effective to determine first transducer profile data for the transducer from the database of transducer profiles based on the characteristics. The processor may be effective to generate interface data based on the characteristics and the first transducer profile data. The processor may be effective to send, by the transceiver, the interface data to a graphic user interface. The processor may be effective to receive, by the transceiver, a selection from the graphic user interface. The processor may be effective to compile the selection, the characteristics, and the first transducer profile data into second transducer profile data. The processor may be effective to generate a program for the transducer based on the second transducer profile data.

Another embodiment of the invention is a system effective to program a transducer or transducer platform. The system may comprise a device and a user interface. The device may comprise a transceiver, a memory, and a processor. The processor may be effective to be in communication with the transceiver and the memory. The processor may be effective to gather characteristics of the transducer by the transceiver through a transducer platform. The processor may be effective to compare the characteristics of the transducer to a database of transducer profiles. The processor may be effective to determine first transducer profile data for the transducer from the database of transducer profiles based on the characteristics. The processor may be effective to generate interface data based on the characteristics and the first transducer profile data. The processor may be effective to send, by the transceiver, the interface data to a display of the graphic user interface. The user interface may be effective to receive the interface data. The user interface may be effective to display interface output based on the interface data on the display. The user interface may be effective to receive a selection. The user interface may be effective to send the selection to the transceiver. The processor may be further effective to receive, by the transceiver, the selection from the graphic user interface. The processor may be effective to compile the selection, the characteristics, and the first transducer profile data into second transducer profile data. The processor may be effective to generate a program for the transducer based on the second transducer profile data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example system depicting an implementation of a transducer programmer;

FIG. 2 illustrates the example system of FIG. 1 with additional detail relating to implementation of a transducer programmer;

FIG. 3 illustrates a flow diagram for an example process to implement a transducer programmer, all arranged according to at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

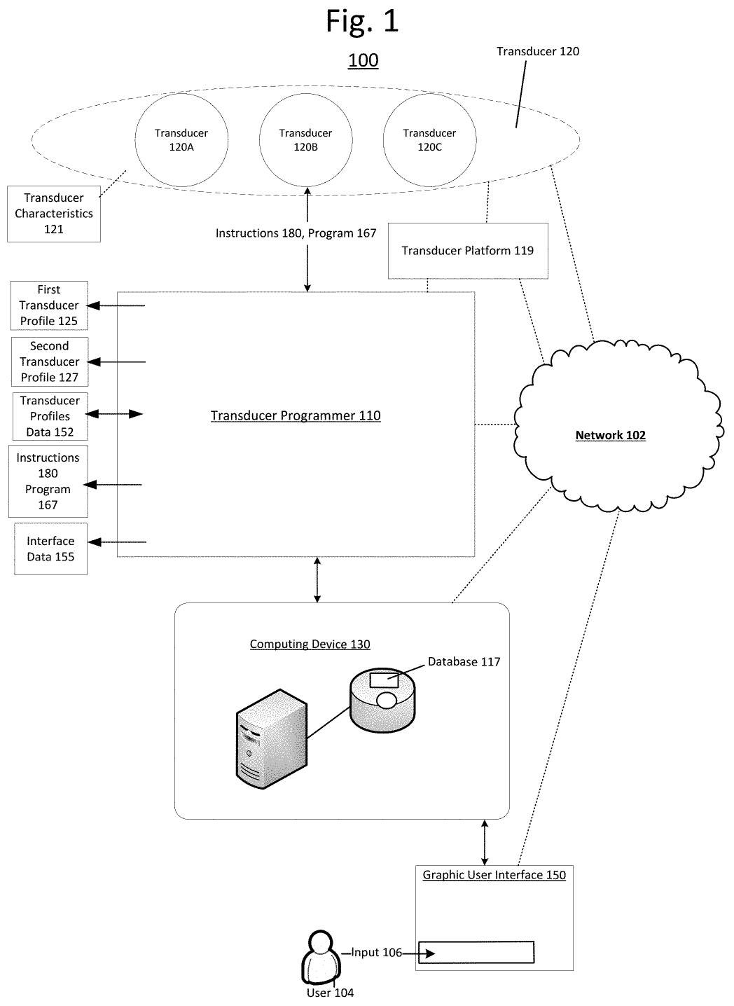

FIG. 1 illustrates an example system 100 depicting an implementation of a transducer programmer, arranged in accordance with at least some embodiments described herein. System 100 may include a transducer programmer 110 and/or one or more transducers 120, such as a transducer 120A, a transducer 120B, and a transducer 120C. Transducers 120A, 120B, and 120C may be integrated into transducer programmer 110 or transducers 120A, 120B, and 120C may be configured to be in communication with transducer programmer 110 through a network 102 and/or a transducer platform 119. Transducer platform 119 may be configured to be in communication with transducers 120, transducer programmer 110, and network 102. Communication between transducers 120, transducer platform 119, network 102 and transducer programmer 110 may be wired, such as universal serial bus (USB), universal asynchronous receiver-transmitter (UART) and/or wireless, such as BLUETOOTH or WIFI. Network 102 may be the Internet, a cellular network, a personal area network, a local area network, a wide area network, etc. In some examples, each transducer 120 may include a microphone, loudspeaker, thermometer, position sensor, pressure sensor, an actuator, etc. System 100 may include the same or different types of transducers 120. For example, transducers 120A and 120B may each include a temperature sensor, and transducer 120C may include a humidity sensor. Transducer programmer 110 may include or be in communication with a computing device 130. As explained in further detail below, computing device 130 may execute modules of transducer programmer 110 to program/control transducer 120.

In some systems, transducer 120 or transducer platform 119 may be programmed with complex programming languages necessitating specialized knowledge in those languages. In system 100, computing device 130 may execute transducer programmer 110 to gather and identify characteristics of transducer 120 and thereafter create a simplified user interface 150. A user 104 may interact with user interface 150 and program transducer 120 without need for a specialized programming background.

Briefly stated, computing device 130 may execute transducer programmer 110 and gather transducer characteristics data 121 of transducer 120. Transducer programmer 110 may compare transducer characteristics data 121 of transducer 120 to a database 117 of transducer profiles and determine/retrieve the corresponding first transducer profile 125 for transducer 120, when transducer 120 measures one variable. First transducer profile 125 may be determined for a single variable measured by transducer 120 when transducer 120 measures more than one variable. Transducer characteristics 121 may include a set of characteristics of the corresponding transducer, a subset of the corresponding transducer profiles 125, complementary transducer profile data, and programming instructions for transducer 120. In some examples, snippets of transducer programming instructions may be part of the transducer profiles data or the transducer characteristics 121. Transducer programmer 110 may thereafter generate interface data 155 based on transducer characteristics data 121 of transducer 120 and the corresponding first transducer profile 125 for transducer 120. In some examples, the interface data may include additional information/metadata relating to the transducer deployment or operation context in the form of controlled vocabularies. Transducer programmer 110 may send interface data 155 to a display 145 of a user interface 150. Transducer programmer 110 may receive one or more selections 106 from a user 104 from user interface 150. Transducer programmer 110 may compile one or more selections 106, transducer characteristics data 121, and corresponding transducer profile 125 into a second transducer profile 127. Transducer programmer 110 may generate instructions 180 for transducer 120 based on second transducer profile 127. Transducer programmer 110 may generate a program 167 for transducer 120 based on instructions 180. Transducer programmer 110 may send program 167 and second transducer profile 127 to transducer 120 or transducer platform 119.

In an example, transducer 120 may measure two or more variables. Transducer programmer 110 may generate a first program 167 for a first variable measured by transducer 120 and transducer programmer 110 may generate a second program 167 for a second variable measured by transducer 120. Transducer programmer 110 may combine the first program 167 for the first variable measured by transducer 120 with the second program 167 for the second variable measured by transducer 120 into a third program. Transducer programmer 110 may send the third program, to transducer 120 or transducer platform 119.

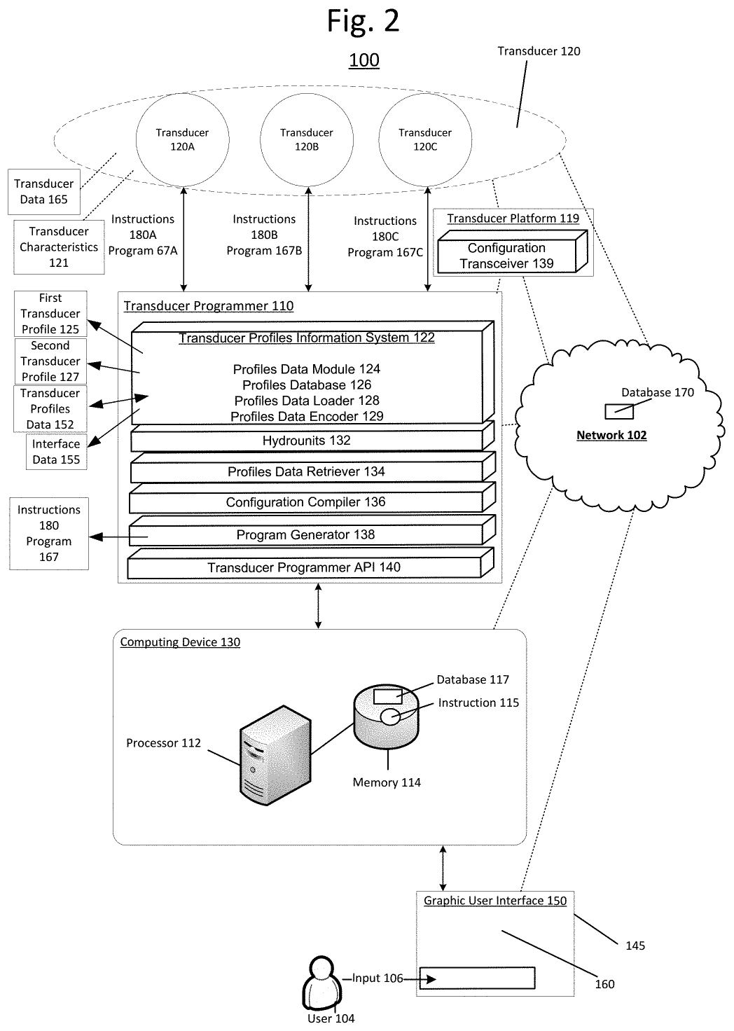

FIG. 2 illustrates an example system 100 depicting an implementation of a transducer programmer, arranged in accordance with at least some embodiments described herein. Those components in FIG. 2 that are labeled identically to components of FIG. 1 will not be described again for the purposes of clarity.

Transducer programmer 110 may include a transducer profiles information system 122. Transducer profiles information system 122 may generate transducer profile 125. Transducer profiles information system 122 may include a profiles data module 124, a profiles database 126, a profiles data loader 128, a profiles data retriever 134 and a profiles data encoder 129. As described in more detail below, transducer profiles information system 122 may gather transducer profiles data 152 for transducer 120.

Transducer programmer 110 may be in communication with computing device 130 over network 102. Computing device 130 may include processor 112 and a memory 114 configured to be in communication with each other. In some examples, computing device 130 may include a desktop computer, a laptop computer, etc. Memory 114 may be configured to store instructions 115 in a database 117. Instructions 115 may include instructions relating to transducer programming. When executed by computing device 130, transducer profiles information system 122 may save transducer profiles data 152 in profiles database 126. Transducer profiles information system 122 may receive a transducer profile 125 for a transducer such as transducer 120. Transducer profiles information system 122 may generate transducer profiles data 152.

When executed by computing device 130, transducer profiles data module 124 may gather transducer profiles data 152 of transducer 120. Transducer profiles data 152 may include data associated with communication protocol, physical interfaces, units, variable measured, accuracy, precision, repeatability, reproducibility, stability, error, noise, drift, resolution, calibration information, sensitivity, measurement range, response, recovery time, etc. Transducer profiles data 152 may be raw information which may require processing to be converted into data similar to the content transducer profile 125. Transducer profiles data 152 may include data from transducer user manuals or datasheets which may be processed either manually or using text processing techniques such as Natural Language Processing techniques. When executed by computing device 130, transducer profiles data module 124 may receive transducer profiles data 152. When executed by computing device 130, profiles data module 124 may gather transducer profiles data 152 either as a batch or individually. When executed by computing device 130, profiles data module 124 may send transducer profiles data 152 to profiles data loader 128, which, in turn, may save transducer profiles data 152 in profiles database 126. In some examples, profiles data module 124 may transform transducer profiles data 152 into SQL scripts or objects or dictionaries that contains the properties or descriptions of transducer 120.

When executed by computing device 130, profiles data module 124 may process transducer profiles data 152 associated with signals output by transducer 120. Transducer profiles data 152 associated with signals output by transducer 120 may provide static characteristics such as calibration information for transducer 120 or transducer profiles of transducer 120 and may be relevant to the operation of transducer 120. Profiles data 152 may include a provision to support dynamic characteristics of transducer 120 for which an output of transducer 120 is a function of an input of transducer 120. When executed by computing device 130, profiles data module 124 may receive transducer profile information sent from profiles data retriever 134 discussed below. When executed by computing device 130, profiles data module 124 may gather, process and format transducer profiles data 152 using natural language processing techniques applied to the transducers manual and datasheets. When executed by computing device 130, profiles data module 124 may gather, process and format transducer profiles data 152 received programmatically through an application programming interface or supplied manually by a user. When executed by computing device 130, profiles data module 124 may send transducer profiles data 152 to profiles database 126.

When executed by computing device 130, profiles database 126 may store transducer profiles data 152 from profiles data module 124. Profiles data 152 in profile database 126 may include transducer profile 125 of each transducer 120 configured to be in communication with transducer programmer 110. Profiles data 152 may include a model identification or number and one or more additional description of each respective transducer 120 to uniquely identify each respective transducer 120 based on a set of transducer properties from transducer characteristics 121 for each respective transducer 120. When executed by computing device 130, profiles data encoder 129 may share a set or a subset of transducer profiles data 127 corresponding to each transducer 120 that may be relevant to a program generator 138.

When executed by computing device 130, profiles data module 124 may generate transducer profiles data 152 which may include fields to describe static characteristics of transducer 120 including, transducer models, communication protocol and/or physical interfaces, units (e.g., degree Celsius, meter), variable(s) measured (e.g., soil moisture, soil temperature), accuracy, precision, repeatability, reproducibility, stability, error, noise, drift, resolution, calibration information, sensitivity, measurement range, response and recovery time. Controlled vocabularies may be used to describe the transducer properties in transducer profiles data 152.

Transducer programmer 110 may include a software component module 132 labeled hydrounits. When executed by computing device 130, hydrounits module 132 may perform unit transformation/conversion and dimensional analysis of transducer profiles data 152 stored in profiles database 126. Unit transformation and dimensional analysis may be based on a binary sequence of bytes that encodes a physical unit of transducer 120 as a product of selected base units, each raised to a rational power in addition to an integer indicating the structure of a unit for each variable measured by transducer 120. When executed by computing device 130, hydrounits module 132 may compute a vectorial representation, for example a binary sequence, of a physical unit of transducer 120, including unforeseen physical units of transducer 120. An unforeseen physical unit of transducer 120 may be a unit with a dimension or a unit which is dimensionless and the unit may have no physical quantity associated to it. Physical unit properties for each transducer 120 in profiles data 152 in profiles database 126 may be processed and converted by hydrounits module 132 to equivalent physical units' properties.

Transducer programmer 110 may include profiles data retriever 134. When executed by computing device 130, profiles data retriever 134 may receive transducer characteristics data 121 from transducer platform 119 or transducers 120 over network 102. When executed by computing device 130, profiles data retriever 134 may determine a corresponding profile 125 for transducer 120 from profiles database 126. When executed by computing device 130, profiles data retriever 134 may determine a corresponding profile for transducer 120 based on transducer characteristics data 121 of transducers 120. In some examples, transducer 120 may measure one or several parameters or quantities and transducer 120 may generate one or several signal as outputs based on the quantities that transducer 120 is designed to measure. When executed by computing device 130, profiles data retriever 134 may retrieve first transducer profile 125 from profiles database 126 pertaining not only to transducer 120 but to each parameter or quantity that transducer 120 is designed to measure. When executed by computing device 130, profiles data retriever 134 may send first transducer profile 125 for transducer 120 from transducer profiles database 126 to profiles data module 124.

Profiles data module 124 may generate interface data 155 at least partially based on transducer characteristics data 121 of transducer 120 and first transducer profile 125 for transducer 120 from transducer programmer 110. Profiles data module 124 may send interface data 155 to graphic user interface 150. Graphic user interface 150 may receive interface data 155 and display interface output 160.

Computing device 130 may host the Transducer programmer 110. Computing device 130 may include or be in communication over network 102 with a display 145 for a graphic user interface (GUI) 150. Transducer programmer 110 may include an application programming interface (API) 140. Graphic user interface 150 may be in communication with transducer programmer 110 through API 140 over network 102. Graphic user interface 150 may be generated from a web-based application. Graphic user interface 150 may enable a user 104 to define inputs that may be relevant to transducers 120 in communication with transducer programmer 110. In an example, graphic user interface 150 may be generated from a desktop-based application and may be a wrapper around a web-based graphic user interface, where graphic user interface 150 may communicate with transducer programmer 110 over network 102. In such a scenario, graphic user interface 150 may permit the interaction and connection between the desktop-based graphic user interface 150 and transducer programmer 110 through the application programming interface (API) 140. In another example, a desktop-based graphic user interface 150 may perform complementary tasks such as discovery of transducers 120 or transducer platform 119 configured to be in communication with the transducers 120 over a serial port (USB, UART) that may be prohibited by a browser-based application. Graphic user interface 150 may facilitate communication with transducers 120 or transducer platform 119 configured to be in communication with transducers 120 over a serial cable (USB, UART, etc.) or network 102.

Interface output 160 of graphic user interface 150 may include options for selection by a user 104. The options displayed on interface output 160 may be predefined controlled vocabularies and may be included in transducers profiles data 152 stored in database 126. The options on interface output 160 may include a manufacturer name of transducer 120, a model number of a transducer 120, a location (e.g., longitude and latitude) for deployment of transducer 120 and/or transducer platform 119, etc. The options displayed on interface output 160 may also be received from transducers 120 or the transducer platform 119 configured to be in communication with transducer 120. Transducer programmer 110 may identify transducers 120A, 120B, 120C connected to transducer programmer 110 or to the transducer platform 119, and output transducer profile 125 including transducer identifications for each respective transducer 120.

User 104 may interact with graphic user interface 150 and may provide one or more selections 106 to graphic user interface 150 such as by using a keyboard, a computer mouse, a microphone to generate speech commands, or a touchscreen if display 145 includes a touchscreen device, etc. Selection 106 may include a selection from options displayed on interface output 160 of graphic user interface 150. User interface 150 may send selection 106 to Transducer programmer 110. Transducer programmer 110 may receive selection 106, and in response, Processor 112 may execute one or more instructions 115 of transducer programmer 110 to transform selection 106 to generate second transducer profile 127. Second transducer profile 127 may include transducer platform configuration data. Second transducer profile 127 may include a transducer electronic datasheet of transducer 120. Transducer programmer 110 may transform selection 106 to generate second transducer profile 127 by encoding the selections of selection 106 based on transducer-related standards, such as the IEEE 1451 standard, SensorML, TransducerML, WaterML, etc. Transducer programmer 110 may send second transducer profile 127 along with program 167 to transducers 120 or to transducer platform 119. As described in more detail below, in response to sending second transducer profile 127 and program 167 to transducers 120 or to transducer platform 119, operation of transducers 120 (120A, 120B, and 120C) and transducer platform 119 may be programmed/controlled based on second transducer profile 127 and program 167.

In an example, user 102 may utilize graphic user interface 150 to log into transducer programmer 110. User 102 may be required to register and authenticate in order to successfully log into transducer programmer 110. User 102 may view interface output 160. Interface output 160 may be generated from interface data 155 and may include selections based upon information gathered by transducer programmer 110. User 102 may select one or more inputs 106. Inputs 106 may include a manufacturer name of transducer 120, a model number of a particular transducer 120, a location (e.g., longitude and latitude) of transducer 120, and one or more inputs that describe either transducer platform 119 or properties of transducer 120.

Transducer programmer 110 may include a configuration compiler 136. When executed by computing device 130, configuration compiler 136 may process inputs or selection 106 from user 104 along with transducer characteristics 121 and first transducer profile 125 generated by profiles data module 124 in the form of the second transducer profile 127. When executed by computing device 130, configuration compiler 136 may compile the resulting second transducer profile 127 into one or more configuration data formats such as a transducer electronic datasheet, JavaScript Object Notation (JSON), XML, or one or more character-encoding techniques suitable for transmission to transducer platform 119 or transducers 120.

Transducer programmer 110 may include a program generator 138. Upon the completion of the compilation of transducer profiles by configuration compiler 136, program generator 138 may be executed by computing device 130 to receive a subset of second transducer profile 127 from configuration compiler 136. When executed by computing device 130, program generator 138 may generate instructions 180 for transducer 120 based on second transducer profile 127. When executed by computing device 130, program generator 138 may generate a program 167 for transducer 120 based on instructions 180. Program generator 138 may generate program 167 in one or several programming languages codes such as Python, C, C++, Java, etc. Program 167 may be generated so as to communicate instructions 180 to transducer 120 in a format compatible with transducer 120. Program generator 138 may generate instructions 180 and a program 167 for each transducer 120 in communication with transducer programmer 110 or transducer platform 119. For example, program generator 138 may generate instructions 180A and a program 167A for transducer 120A based on the compiled transducer profiles for transducer 120A. Program generator 138 may generate instructions 180B and a program 167B for transducer 120B based on the compiled transducer profiles for transducer 120B.

Transducer platform 119 may operate on network 102 and may be connected to the transducer programmer 110 through the graphic user interface 150. Transducer platform 119 may include a configuration transceiver 139. Configuration transceiver 139 may act as both a receiver and a transmitter. Configuration transceiver 139 may receive configurations of transducer 120 and program 167 from transducer programmer 110. Transducer platform 119 or transducers 120 may organize, dispatch, and store one or more second transducer profiles 127 of transducer 120 and program 167 internally. In some examples, transducer platform 119 may store transducer characteristics 121 in an intermediate database 170 using web storage techniques. In some examples, the transducer programmer 110 may store one or more second transducer profiles 127 of transducer 120 and program 167 in an intermediate database 170 using web storage techniques. In some examples, transducer platform 119 or transducers 120 may collect one or more second transducer profiles 127 of transducer 120 and program 167 from the intermediate database. In some examples, intermediate database may utilize web storage techniques such as local storage and may be database 117 of computing device 130. In another example, intermediate database may utilize session storage and may be database 170 residing on display 145. Intermediate database 117 or 170 may be used to temporarily store transducer characteristics 121, transducer profiles 127, instructions 180, and program 167. Transducer programmer 110 may be in communication with intermediate database 117 or 170.

Transducer platform 119 or transducers 120 may be (pre-)loaded with firmware and data reception and transmission protocols to process incoming encoded and non-encoded data from transducer programmer 110, intermediate database 117 or 170. Transducer platform 119 may identify and organize compiled second transducer profiles 127 and program 167 for each transducer 120A, 120B and 120C. Configuration transceiver 139 may report any failure or success in the processing of compiled transducer profiles 127, program 167 and transducer characteristics 121. In response to loading compiled transducer profiles 127 and program 167 to transducer platform 119 or transducers 120, transducers 120 may be controlled based on compiled transducer profiles 127 and program 167. Further, based on instructions 180 in the program 167 or in configuration transceiver 139, configuration transceiver 139 or transducers 120 may communicate and exchange compiled transducer profiles 127 and transducer data 165 with one or more other configuration transceiver 139, transducers 120, computing devices, or servers which may serve as a base station.

When executed by computing device 130, transducer programmer 110 may utilize transducer characteristics 121 of transducer 120 to retrieve additional metadata from profile database 126 including controlled vocabularies that may aid in discovery of transducer data 165 for transducer 120. When executed by computing device 130, transducer programmer 110 may utilize characteristics 121 of transducer 120 to retrieve additional metadata from profile database 126 including controlled vocabularies that may aid in interpretation and integration of transducer data 165. The Transducer programmer 110 may include the additional metadata as part of the second transducer profile 127 and may be used in program 167. The Transducer programmer 110 may utilize characteristics 121 of transducer 120 to generate a program to control transducer 120 attached to transducer programmer 110 or transducer platform 119.

Transducer programmer 110 and computing device 130 may use inputs 106, transducer profiles data 152 to support processes related to transducer 120 to generate program 167. Program 167 may be executed by transducers 120 or the transducer platform 119 to control attached transducers 120. Computing device 130 and transducer programmer 110 may receive selection 106 from user 102 and, in response, the configuration compiler 136 may transform the received selections 106 and/or may subdivide the selections 106 into one or more categories with each subcategory assembled into one or more compiled transducer profiles data formats. For example, selections 106 may be subdivided into one or more transducer electronic datasheets for each corresponding transducer 120.

A system in accordance with the present disclosure may reduce the transmission of transducer profiles between transducer data processing applications. A system in accordance with the present disclosure may require only a transmission of an identifier of a transducer which may be retrieved on-the-fly using a transducer unique identifier code. The system may seamlessly facilitate data integration and analysis from diverse transducer data sources or information systems. Furthermore, the system may develop a transducers identification web service where metadata or profiles data for each transducer and transducer channels may be extracted. The system may provide an information system which may be useful to managers of transducer networks and those who perform technical tasks on transducers such as transducer rotation between transducer platforms or configuration transceivers.

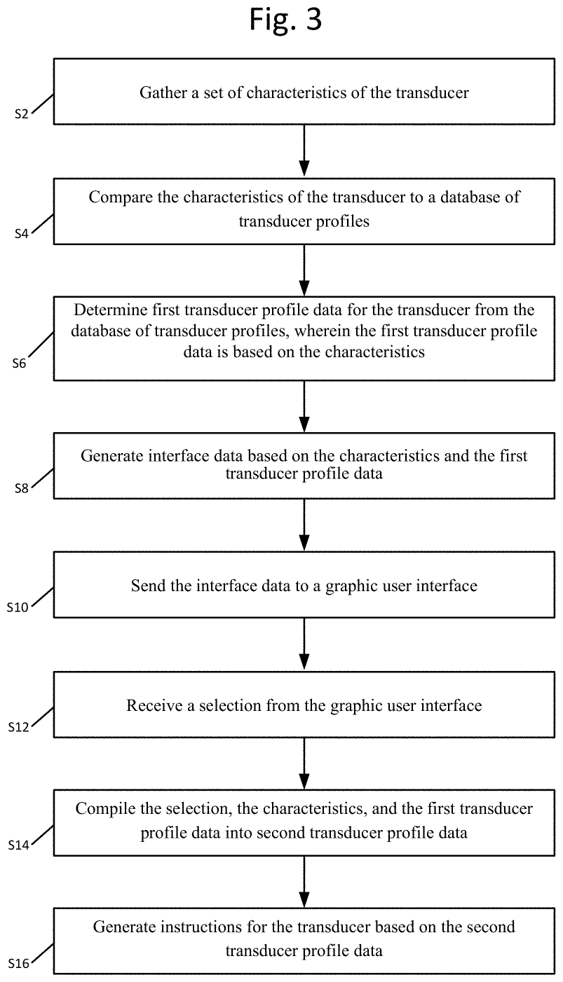

FIG. 3 illustrates a flow diagram for an example process to implement a transducer programmer, arranged in accordance with at least some embodiments presented herein. The process in FIG. 3 could be implemented using, for example, system 100 discussed above. An example process may include one or more operations, actions, or functions as illustrated by one or more of blocks S2, S4, S6, S8, S10, S12, S14, and/or S16. Although illustrated as discrete blocks, various blocks may be divided into additional blocks, combined into fewer blocks, or eliminated, depending on the desired implementation.

Processing may begin at block S2, “Gather a set of characteristics of the transducer”. At block S2, a processor may gather characteristics of the transducer. Transducer characteristics may include a set of characteristics of the corresponding transducer, a subset of the corresponding transducer profiles data, complementary transducer profile data, and programming instructions for the transducer.

Processing may continue from block S2 to block S4, “Compare the characteristics of the transducer to a database of transducer profiles”. At block S4, the processor may compare the characteristic to a database of transducer profiles. The database of transducer profiles may include data associated with communication protocol, physical interfaces, units, variable measured, accuracy, precision, repeatability, reproducibility, stability, error, noise, drift, resolution, calibration information, sensitivity, measurement range, response, recovery time, etc.

Processing may continue from block S4 to block S6, “Determine first transducer profile data for the transducer from the database of transducer profiles, wherein the first transducer profile data is based on the characteristics”. At block S6, the processor may determine first transducer profile data for the transducer from the database of transducer profiles. The first transducer profile data may be based on the characteristics of the transducer.

Processing may continue from block S6 to block S8, “Generate interface data based on the characteristics and the first transducer profile data”. At block S8, the processor may generate interface data based on the characteristics of the transducer and the first transducer profile data.

Processing may continue from block S8 to block S10, “Send the interface data to a graphic user interface”. At block S10, the processor may send the interface data to a graphic user interface. The graphic user interface may be in communication with the processor through a transducer platform application programming interface (API). The processor 130 may include or be in communication with a display for the graphic user interface. The graphic user interface may be generated from a web-based application. The graphic user interface may enable a user to define inputs that may be relevant to the transducer. The graphic user interface may be generated from a desktop-based application and may be a wrapper around a web-based graphic user interface. An interface output of the graphic user interface may include options for selection by the user. Selections displayed on the interface output may be predefined controlled vocabularies and/or may be included in the profiles of transducers stored in the database. The selections on the interface output may include a manufacturer name of the transducer, a model number of the transducer, a location (e.g., longitude and latitude) of the transducer, etc. The selections displayed on the interface output may also be received from the transducer or a transducer platform configured to be in communication with the transducer.

Processing may continue from block S10 to block S12, “Receive a selection from the graphic user interface”. At block S12, the processor may receive a selection from the graphic user interface. The user may interact with the graphic user interface and may provide one or more selections to the graphic user interface such as by using a keyboard, a computer mouse, a microphone to generate speech commands, or a touchscreen if the graphic user interface includes a touchscreen device, etc. The selection may include a selection from options displayed on the interface output of the graphic user interface.

Processing may continue from block S12 to block S14, “Compile the selection, the characteristics, and the first transducer profile data into second transducer profile data”. At block S14, the processor may compile the selection, the characteristics and the first transducer profile. The processor may compile the results into one or more configuration data formats such as a transducer electronic datasheet suitable for transmission to the transducer platform or the transducers, JavaScript Object Notation (JSON), XML, etc.

Processing may continue from block S14 to block S16, “Generate instructions for the transducer based on the second transducer profile data”. At block S16, the processor may generate instructions for the transducer. The instructions may be based on the second transducer profile data. The processor may generate a program for the transducer based on the instructions.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method to program a transducer, the method comprising, by a processor:
gathering a set of characteristics of the transducer;
comparing the characteristics of the transducer to a database of transducer profiles;
determining first transducer profile data for the transducer from the database of transducer profiles, wherein the first transducer profile data is based on the characteristics;
generating interface data based on the characteristics and the first transducer profile data;
sending the interface data to a graphic user interface;
receiving a selection from the graphic user interface;
compiling the selection, the characteristics, and the first transducer profile data into second transducer profile data; and
generating instructions for the transducer based on the second transducer profile data.

2. The method of claim 1, further comprising;
generating a program for the transducer based on the instructions; and
sending the program and second transducer profile data to the transducer or a transducer platform.

3. The method of claim 1, wherein the database of transducer profiles is stored in a computing device.

4. The method of claim 1, further comprising retrieving the database of transducer profiles over a network.

5. The method of claim 1, wherein the profiles data of the transducer include one or more of: communication protocol, physical interfaces, units, variable measured, accuracy, precision, repeatability, reproducibility, stability, error, noise, drift, resolution, calibration information, sensitivity, measurement range, response, and recovery time.

6. The method of claim 1, wherein the transducer is a first transducer, the characteristics are first characteristics, the interface data is first interface data, the selection is a first selection, and the program is a first program, the method further comprising:
connecting a second transducer to a transducer platform, wherein the second transducer and the transducer platform are in communication;
gathering second set of characteristics of the second transducer by the transducer platform;
comparing the second characteristics of the second transducer to a database of transducer profiles;
determining third transducer profile data for the second transducer from the database of transducer profiles based on the second characteristics;
generating second interface data based on the second characteristics and the third transducer profile data;
sending the second interface data to the graphic user interface;
receiving a second selection from the graphic user interface;
compiling the second selection, the second characteristics, and the third transducer profile data into fourth transducer profile data; and
generating a second program for the second transducer based on the fourth transducer profile data.

7. The method of claim 6, further comprising:
combining the first program and the second program into a third program; and
sending the third program, the second transducer profile data, and the fourth transducer profile data to the transducer or a transducer platform.

8. The method of claim 1, wherein the characteristics are first characteristics used to determine profiles data for a first variable measured by the transducer, the interface data is first interface data, the selection is a first selection, and the program is a first program, the method further comprising:
comparing the first characteristics to the database of transducer profiles;
determining third transducer profile data for a second variable measured by the transducer from the database of transducer profiles based on the first characteristics;
generating second interface data based on the first characteristics and the third transducer profile data;
sending the second interface data to the graphic user interface;
receiving a second selection from the graphic user interface;
compiling the second selection, the first characteristics, and the third transducer profile data into fourth transducer profile data; and
generating a second program for the second variable measured by the transducer based on the fourth transducer profile data.

9. The method of claim 8, further comprising:
combining the first program and the second program into a third program; and
sending the third program, the second transducer profile data, and the fourth transducer profile data to the transducer or a transducer platform.

10. A device effective to program a transducer, the device comprising:
a transceiver;
a memory; and
a processor effective to be in communication with the transceiver and the memory;
wherein the processor is effective to:
gather characteristics of the transducer by the transceiver;
compare the characteristics of the transducer to the database of transducer profiles;
determine first transducer profile data for the transducer from the database of transducer profiles based on the characteristics;
generate interface data based on the characteristics and the first transducer profile data;
send, by the transceiver, the interface data to a graphic user interface;
receive, by the transceiver, a selection from the graphic user interface;
compile the selection, the characteristics, and the first transducer profile data into second transducer profile data; and
generate a program for the transducer based on the second transducer profile data.

11. The device of claim 10, further comprising the processor effective to send, by the transceiver, the program and second transducer profile data to the transducer or transducer platform.

12. The device of claim 10, wherein the characteristics are first characteristics used to determine profiles data for a first variable measured by the transducer, the interface data is first interface data, the selection is a first selection, and the program is a first program, the processor further:
compare the first characteristics to the database of transducer profiles;
determine third transducer profile data for a second variable measured by the transducer from the database of transducer profiles based on the first characteristics;
generating second interface data based on the first characteristics and the third transducer profile data;
send the second interface data to the graphic user interface;
receive a second selection from the graphic user interface;
compile the second selection, the first characteristics, and the third transducer profile data into fourth transducer profile data; and
generate a second program for the second variable measured by the transducer based on the fourth transducer profile data.

13. The device of claim 12, wherein the processor is further effective to:
combine the first program and the second program into a third program; and
send the third program, the second transducer profile data, and the fourth transducer profile data to the transducer or a transducer platform.

14. The device of claim 10, wherein the transducer is a first transducer, the characteristics are first characteristics, the interface data is first interface data, the selection is a first selection, and the program is a first program, the processor further effective to:
connect to a second transducer to a transducer platform, wherein the second transducer and the transducer platform are in communication;
gather second characteristics of the second transducer by the transducer platform;
compare the second characteristics of the second transducer to the database of transducer profiles;
determine third transducer profile data for the second transducer from the database of transducer profiles based on the second characteristics;
generate second interface data based on the second characteristics and the third transducer profile data;
send the second interface data to the graphic user interface;
receive a second selection from the graphic user interface;
compile the second selection, the second characteristics, and the third transducer profile data into fourth transducer profile data; and
generate a second program for the second transducer based on the fourth transducer profile data.

15. A system effective to program a transducer or transducer platform, the system comprising:
a device; and
a user interface;
wherein the device comprises:
a transceiver;
a memory; and
a processor effective to be in communication with the transceiver and the memory;
wherein the processor is effective to:
gather characteristics of the transducer by the transceiver through a transducer platform;
compare the characteristics of the transducer to a database of transducer profiles;
determine first transducer profile data for the transducer from the database of transducer profiles based on the characteristics;
generate interface data based on the characteristics and the first transducer profile data;
send, by the transceiver, the interface data to a display of the graphic user interface;
the user interface effective to:
receive the interface data;
display interface output based on the interface data on the display;
receive a selection; and
send the selection to the transceiver;
the processor further effective to:
receive, by the transceiver, the selection from the graphic user interface;
compile the selection, the characteristics, and the first transducer profile data into second transducer profile data; and
generate a program for the transducer based on the second transducer profile data.

16. The system of claim 15, wherein the processor is further effective to send, by the transceiver, the program to the transducer.

17. The system of claim 15, wherein the characteristics are first characteristics used to determine profiles data for a first variable measured by the transducer, the interface data is first interface data, the selection is a first selection, and the program is a first program, the processor further effective to:
compare the first characteristics to the database of transducer profiles;
determine third transducer profile data for a second variable measured by the transducer from the database of transducer profiles based on the first characteristics;
generate second interface data based on the first characteristics and the third transducer profile data;
send the second interface data to the graphic user interface;
receive a second selection from the graphic user interface;
compile the second selection, the first characteristics, and the third transducer profile data into fourth transducer profile data; and
generate a second program for the second variable measured by the transducer based on the fourth transducer profile data.

18. The system of claim 17, wherein the processor is further effective to:
combine the first program and the second program into a third program; and
send the third program, the second transducer profile data, and the fourth transducer profile data to the transducer or a transducer platform.

19. The system of claim 15, wherein the transceiver is in communication with the user interface over a network.

20. The system of claim 15, wherein the transducer is a first transducer, the characteristics are first characteristics, the interface data is first interface data, the selection is a first selection, the program is a first program, and the interface output is first interface output, the processor further effective to:
connect a second transducer to a transducer platform, wherein the second transducer and the transducer platform are in communication;
gather second characteristics of the second transducer by the transceiver through the transducer platform;
compare the second characteristics of the second transducer to the database of transducer profiles;
determine third transducer profile data for the second transducer from the database of transducer profiles based on the second characteristics;
generate second interface data based on the second characteristics and the third transducer profile data;
send the second interface data to the graphic user interface;
the user interface effective to:
receive the second interface data;
display second interface output based on the second interface data;
receive a second selection; and
send the second selection to the transceiver;
the processor further effective to:
receive, by the transceiver, the second selection from the graphic user interface;
compile the second selection, the second characteristics, and the third transducer profile data into fourth transducer profile data; and
generate a second program for the second transducer based on the fourth transducer profile data.
